(19) United States
(12) Patent Application Publication
(10) Pub. No.: US 2007/0205965 A1
(43) Pub. Date: Sep. 6, 2007

(54) METHOD OF DRIVING PLASMA DISPLAY PANEL

(76) Inventor: Joo-Yul Lee, Suwon-si (KR)

Correspondence Address: CHRISTIE, PARKER & HALE, LLP, PO BOX 7068, PASADENA, CA, 91109-7068, US

(21) Appl. No.: 11/680,564

(22) Filed: Feb. 28, 2007

(30) Foreign Application Priority Data
Mar. 3, 2006 (KR) 10-2006-0020401

(51) Int. Cl. G09G 3/28

(52) U.S. Cl. 345/63

(57) ABSTRACT

A method of driving a plasma display panel (PDP) by stably performing sustain and reset discharges. The PDP includes first and second electrode lines, and third electrode lines extending to cross the first and second electrode lines, wherein discharge cells are defined where the first, second and third electrode lines cross, the first electrode lines include first type electrode lines and second type electrode lines that are alternately arranged, and the discharge cells include first and second discharge cell groups respectively defined by the first and second type electrode lines. The method includes: performing a first address operation for addressing the first discharge cell group; performing a first sustain operation in the discharge cells addressed in the first address operation; performing a second address operation for addressing the second discharge cell group; and performing a second sustain operation in the discharge cells addressed in the first and second address operations.

### CROSS-REFERENCE TO RELATED PATENT APPLICATION

This application claims priority to and the benefit of Korean Patent Application No. 10-2006-0020401, filed on Mar. 3, 2006 in the Korean Intellectual Property Office, the entire content of which is incorporated herein by reference.

### BACKGROUND OF THE INVENTION

1. Field of the Invention

The present invention relates to a method of driving a plasma display panel, and more particularly, to a method of driving subfields in a plasma display panel.

2. Description of the Related Art

Plasma displays having a plasma display panel (PDP), which have replaced conventional cathode ray tube (CRT) display devices, are devices in which a discharge gas is sealed between two substrates having a plurality of electrodes that are formed in a predetermined pattern. In a PDP, discharge voltage is applied between the plurality of electrodes, and ultraviolet rays generated by applying the discharge voltage excite phosphors to obtain a desired image.

A plasma display panel is driven by performing sustain discharge in discharge cells where a plurality of electrodes cross one another. In this regard, various driving methods are used. For example, there are a progressive method and an interlacing method. In the progressive method, addressing is performed by sequentially applying scan pulses to scan electrode lines of the plurality of electrodes. In the interlacing method, scan electrode lines are categorized into odd-numbered lines and even-numbered lines, scan pulses are applied to the odd-numbered lines, and then, scan pulses are applied to the even-numbered lines.

An alternate lighting of surfaces method (ALIS method) is disclosed as an example of the interlacing method in Korean Laid-Open Patent Publication No. 2002-0096828. In the ALIS method, reset discharge is performed in discharge cells corresponding to only odd-numbered lines of sustain electrode lines of a plurality of electrode lines, and address discharge is sequentially performed in the discharge cells during addressing (address discharge), in order to improve the interlacing method that has a disadvantage that display quality is lower than in the progressive method.

However, in the ALIS method, sustain discharge is not performed in the discharge cells formed by the odd-numbered lines of the sustain electrode lines (hereinafter referred to as “first discharge cell group) after address discharge until performing of address discharge in discharge cells formed by even-numbered lines of the sustain electrode lines (hereinafter referred to as “second discharge cell group) is completed. Thus, a waiting time between address discharge and sustain discharge is long, thus preventing first sustain discharge from being stably performed. Also, reset discharge is not performed in the second discharge cell group until performing of reset discharge and address discharge in the first discharge cell group is completed after performing sustain discharge in all subfields. Accordingly, a waiting time is increased, thus preventing reset discharge from being stably performed.

### SUMMARY OF THE INVENTION

An exemplary embodiment of the present invention provides a method of driving a plasma display panel, so that sustain discharge and reset discharge can be stably performed when using the ALIS method.

According to an aspect of the present invention, a method of driving a plasma display panel is provided. The plasma display panel includes: first electrode lines extending in a first direction, second electrode lines each being located between adjacent ones of the first electrode lines and extending in parallel with the first electrode lines, and third electrode lines extending to cross the first and second electrode lines, wherein discharge cells are defined where the first, second and third electrode lines cross, the first electrode lines include first type electrode lines and second type electrode lines that are alternately arranged, and the discharge cells include a first discharge cell group defined by the first type electrode lines and a second discharge cell group defined by the second type electrode lines. The method includes: performing a first address operation for selecting one or more of the discharge cells in the first discharge cell group; performing a first sustain operation in said one or more of the discharge cells selected in the first address operation; performing a second address operation for selecting one or more of the discharge cells in the second discharge group; and performing a second sustain operation in said one or more of the discharge cells selected in the first address operation and said one or more of the discharge cells selected in the second address operation.

The method may further include performing a first reset operation for initializing the first discharge cell group before the first address operation; and performing a second reset operation for initializing the second discharge cell group before the second address operation.

A unit frame for displaying an image on the plasma display panel may include a plurality of subfields, each subfield including the first reset operation, the first address operation, the first sustain operation, the second reset operation, the second address operation, and the second sustain operation.

Sustain discharge may be performed in a discharge cell among the discharge cells in the second discharge cell group, which is addressed in the second address operation of a subfield right before a current subfield among the subfields, in the first sustain operation of the current subfield.

In the first sustain operation, sustain discharge may be performed a predetermined number of times, and a sum of numbers of times that sustain discharge is respectively performed in the first and second sustain operations, may correspond to a gray-level weight allocated to each of the subfields.

At least one subfield among the subfields may further include a third sustain operation in which sustain discharge is performed in only the second discharge cell group so as to compensate for sustain discharge which is performed in the second discharge cell group less frequently than in the first discharge cell group.

A last subfield of the subfields may include the third sustain operation.

The third sustain operation may be performed before performing the second sustain operation.

The third sustain operation may be performed after performing the second sustain operation.

In the first reset operation, a reset pulse including a rising pulse and a falling pulse may be applied to the second electrode lines. During application of the rising pulse, a first voltage may be applied to the first electrode lines of the first discharge cell group in order to perform reset discharge, and a second voltage may be applied to the first electrode lines of the second discharge cell group in order not to perform reset discharge, wherein the second voltage is greater than the first voltage.

During application of the falling pulse, a third voltage may be applied to the first electrode lines of the first discharge cell group and the first voltage may be applied to the first electrode lines of the second discharge cell group, wherein the third voltage has positive polarity and is greater than the first voltage.

In the first address operation, a scan pulse may be sequentially applied to the second electrode lines and a display data signal may be applied to the third electrode lines so as to perform address discharge in the first discharge cell group.

In the first address operation, a sustain pulse may be alternately applied to the first electrode lines and the second electrode lines so as to perform sustain discharge in the selected one or more of the discharge cells a predetermined number of times.

In the second reset operation, a reset pulse including a rising pulse and a falling pulse may be applied to the second electrode lines. During application of the rising pulse, a first voltage may be applied to the first electrode lines of the second discharge cell group so as to perform reset discharge and a second voltage may be applied to the first electrode lines of the first discharge cell group so as not to perform reset discharge, wherein the second voltage is greater than the first voltage.

During application of the falling pulse, a third voltage may be applied to the first electrode lines of the second discharge cell group and the first voltage may be applied to the first electrode lines of the first discharge cell group, where the third voltage has positive polarity and is greater than the first voltage.

In the second address operation, a scan pulse may be sequentially applied to the second electrode lines and a display data signal may be applied to the third electrode lines so as to perform address discharge in the second discharge cell group.

In the second sustain operation, a sustain pulse may be alternately applied to the first electrode lines and the second electrode lines so as to perform sustain discharge in the addressed discharge cell.

In the third sustain operation, a sustain pulse which transitions from logic high to logic low may be applied to the second electrode lines of the first discharge cell group, and a sustain pulse which transitions from logic low to logic high may be applied to the second electrode lines of the second discharge cell group.

Before application of the rising pulse and the falling pulse, an erasure pulse may be applied to the first electrode lines or the second electrode lines, wherein the erasure pulse is performed for erasing sustain discharge in one or more of the discharge cells.

The predetermined number of times may be 1.

### BRIEF DESCRIPTION OF THE DRAWINGS

The above and other features and aspects of the present invention will become more apparent by describing in detail exemplary embodiments thereof with reference to the attached drawings in which:

FIG. 1 is an electrode layout of a plasma display panel to which a method of driving a plasma display panel according to an embodiment of the present invention, is applied;

FIG. 2 is a diagram illustrating the structure of a unit frame for displaying an image according to an embodiment of the present invention;

FIGS. 3A, 3B and 3C are diagrams illustrating in more detail the structure of an eighth subfield of subfields illustrated in FIG. 2 according to embodiments of the present invention;

FIG. 4 is a schematic block diagram of a plasma display including a plasma display panel to which a method of driving a plasma display panel according to an embodiment of the present invention, is applied;

FIG. 5 is a timing diagram of driving signals according to an embodiment of the present invention;

FIG. 6 is a timing diagram of driving signals according to another embodiment of the present invention; and

FIG. 7 is a timing diagram of driving signals according to an embodiment of the present invention.

### DETAILED DESCRIPTION

Hereinafter, exemplary embodiments of the present invention will be described in detail with reference to the accompanying drawings.

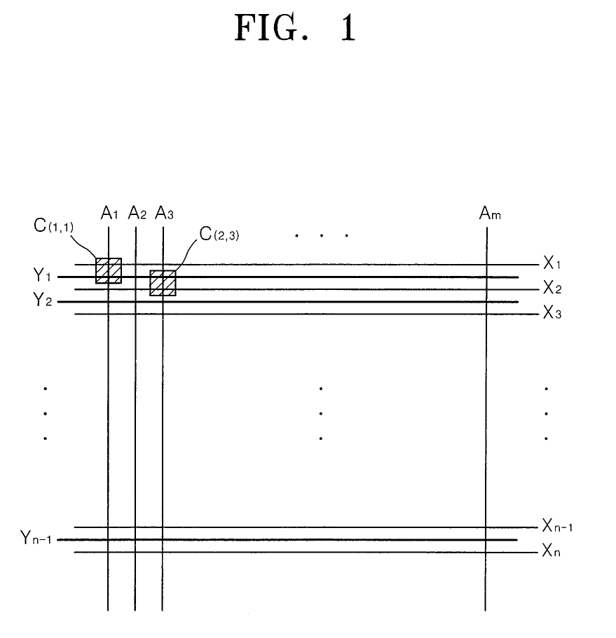

FIG. 1 is an electrode layout of a plasma display panel in which a method of driving a plasma display panel according to an embodiment of the present invention, is applied. Referring to FIG. 1, first electrode lines X1, . . . , Xn extend along a lengthwise direction in the plasma display panel, and each of second electrode lines Y1, . . . , Yn−1 extends between adjacent ones of the first electrode lines X1, . . . , Xn and in parallel with the first electrode lines X1, . . . , Xn (i.e., along a lengthwise direction in the plasma display panel). Third electrode lines A1, . . . , Am extend while crossing the first electrode lines X1, . . . , Xn and the second electrode lines Y1, . . . , Yn−1, that is, they extend along a longitudinal direction in the plasma display panel. Discharge cells are defined in regions where the first electrode lines X1, . . . , Xn, the second electrode lines Y1, . . . , Yn−1, and the third electrode lines A1, . . . , Am cross one another. Hereinafter, the first electrode lines X1, . . . , Xn will be referred to as “sustain electrode lines”, the second electrode lines Y1, . . . , Yn−1 will be referred to as “scan electrode lines”, and the third electrode lines A1, . . . , Am will be referred to as “address electrode lines”. Since a method of driving a plasma display panel according to an embodiment of the present invention uses the ALIS method, each of the scan electrode lines Y1, . . . , Yn−1 is arranged between adjacent ones of the sustain electrode lines X1, . . . , Xn. This arrangement reduces the number of the scan electrode lines Y1, . . . , Yn−1 and the size of discharge cells, thereby realizing a high-definition plasma display panel. In the electrode layout of FIG. 1, n×m discharge cells are formed.

In the embodiment of the present invention, a group of discharge cells formed by the odd-numbered lines X1, X3, . . . , Xn−1 (XG1) of the sustain electrode lines X1, . . . , Xn will be referred to as “first discharge cell group G1”, and a group of discharge cells formed by the even-numbered lines X2, X4, . . . , Xn (XG2) of the sustain electrode lines X1, . . . , Xn will be referred to as “second discharge cell group G2”. That is, the discharge cells formed by the first sustain electrode line X1, the third sustain electrode line X3, . . . , the n−1^{th} sustain electrode line Xn−1 will be referred to as “first discharge cell group G1”. C(1,1) is illustrated as an example of a discharge cell in the first discharge cell group G1. The discharge cells formed by the second sustain electrode line X2, the fourth sustain electrode line X4, . . . , the n^{th} sustain electrode line Xn will be referred to as “second discharge cell group G2”. C(2,3) is illustrated as an example of a discharge cell in the second discharge cell group G2. In a method of driving a plasma display panel according to an embodiment of the present invention, reset discharge, addressing, and sustain discharge are performed separately in the first and second discharge cell groups G1 and G2, which will be described later.

An example of a plasma display panel includes a front substrate and a rear substrate. Between the front substrate and the rear substrate, address electrode lines, dielectric layers, scan electrode lines, sustain electrode lines, phosphor layers, barrier ribs, and an MgO protective layer are formed.

The address electrode lines are formed on a front surface of the rear substrate in a predetermined pattern. A rear dielectric layer is formed on the address electrode lines. The barrier ribs are formed in parallel with the address electrode lines, on top of the rear dielectric layer. The barrier ribs define a discharge region for each of discharge cells, and prevent optical cross talk from occurring between adjacent discharge cells. The phosphor layers are formed on the rear dielectric layer on the address electrode lines and between the barrier ribs. A red-light emitting phosphor layer, a green-light emitting phosphor layer, and a blue-light emitting phosphor layer are sequentially applied in the discharge cells.

The sustain electrode lines and the scan electrode lines are formed in a predetermined pattern on the front substrate so that they can be at right angles to the address electrode lines. In one embodiment, each of the sustain electrodes and each of the scan electrodes is manufactured by combining a transparent electrode line, which is formed of a transparent conductive material such as an indium tin oxide (ITO), and a metal electrode (bus electrode) that improves conductivity. A front dielectric layer is applied on the sustain electrode lines and the scan electrode lines to completely cover the resultant structure. The MgO protective layer is applied on the front dielectric layer to cover the resultant structure in order to protect the plasma display panel from a strong electric field. A discharge gas, for plasma formation, is sealed up in a discharge space defined between the substrates.

The structure of the above plasma display panel is just an example, that is, a type of plasma display panel to which a method of driving a plasma display panel in embodiments according to the present invention is applicable, and the present invention is not limited thereto. In other words, the method of driving the plasma display panel according to exemplary embodiments of the present invention, can be applied to any type of plasma display panel that has scan electrode lines and sustain electrode lines, which are formed in parallel, and address electrode lines extending to cross the scan electrode lines and the sustain electrode lines.

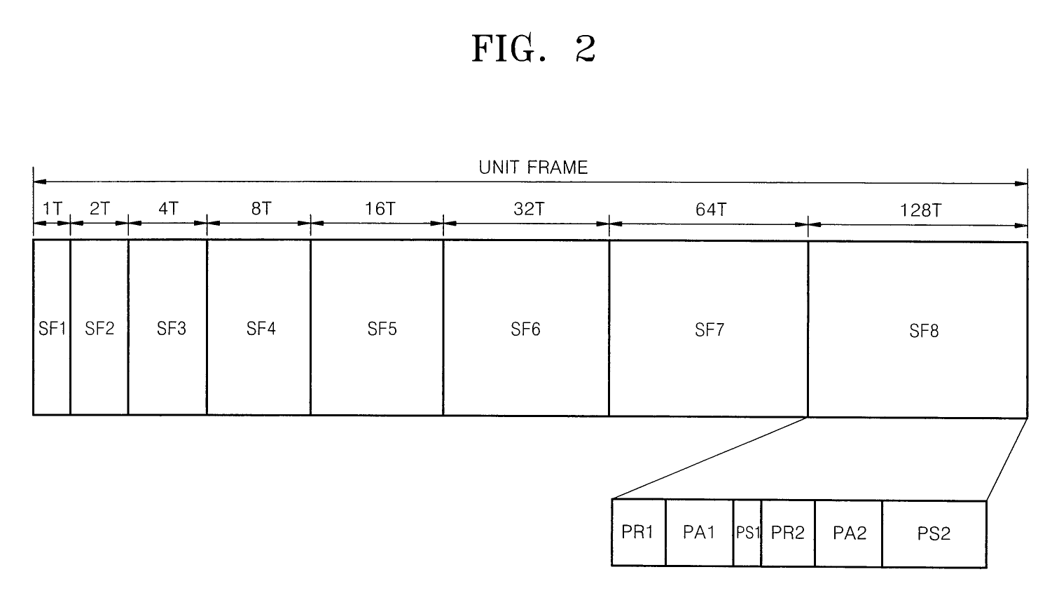

FIG. 2 is a diagram illustrating the structure of a unit frame for displaying an image according to an embodiment of the present invention. Referring to FIG. 2, the unit frame is divided into a plurality of subfields. As illustrated in FIG. 2, a unit frame in one embodiment has eight subfields each having a first reset period PR1, a first address period PA1, a first sustain period PS1, a second reset period PR2, a second address period PA2, and a second sustain period PS2.

In the first reset period PR1, all the discharge cells belonging to the first discharge cell group G1 of the entire discharge cells are initialized. In the first address period PA1, the discharge cells belonging to the first discharge cell group G1 are addressed, where discharge cells to be turned on and discharge cells not to be turned on are differentiated from one another. In the first sustain period PS1, sustain discharge is performed in the discharge cells selected (addressed) in the first address period PA1, a predetermined number of times. Here, the predetermined number of times can be adjusted according to a designer's intention. By way of example, the predetermined number is 1 in one embodiment. During the first reset period PR1, all the discharge cells belonging to the second discharge cell group G2 are not initialized. During the first address period PA1, the discharge cells belonging to the second discharge cell group G2 are not addressed as they have not been initialized in the first reset period PR1. Accordingly, sustain discharge is not performed in the second discharge cell group G2 during the first sustain period PS1.

In the second reset period PR2, all the discharge cells belonging to the second discharge cell group G2 are initialized. In the second address period PA2, the discharge cells belonging to the second discharge cell group G2 are addressed, where discharge cells to be turned on and discharge cells not to be turned on are differentiated from one another. In the second sustain period PS2, sustain discharge is performed a predetermined number of times in the discharge cells selected (addressed) in the first address period PA1 and the second address period PA2. The discharge cells of the first discharge cell group G1 are not initialized and addressed in the second reset period PR2 and the second address period PA2, respectively.

Unlike in the prior art, according to the present invention, each subfield has the first sustain period PS1 interposed between the first address period PA1 and the second reset period PR2. Accordingly, sustain discharge is performed in the first discharge cell group G1 a predetermined number of times in the first sustain period PS1 right after the discharge cells of the first discharge cell group G1 are addressed in the first address period PA1, and then, sustain discharge is performed therein again in the second sustain period PS2, thereby reducing a waiting time incurred between addressing and sustain discharge. For this reason, sustain discharge can be performed more stably than in the prior art. Also, conventionally, since the first sustain period PS1 is not present, the time difference between sustain discharge in the second discharge cell group G2 in the second sustain period PS2, and the second reset period PR2 in a subsequent subfield is long, thus preventing reset discharge from being stably performed in the second discharge cell group G2. In contrast, according to the described embodiments of the present invention, since each subfield has the first sustain period PS1, a discharge cell belonging to the second discharge cell group G2, where sustain discharge is performed in the second sustain period PS2 of the subfield, is initialized in the second reset period PR2 after sustain discharge is performed in the first sustain period PS1 of a subsequent subfield. Accordingly, a waiting time between sustain period and reset period is reduced, thereby stably performing reset discharge.

In FIG. 2, a unit frame is divided into eight subfields SF1 through SF8, and gray-level weights 1T, 2T, . . . , 128T are allocated to them, respectively. However, the present invention is not limited thereto. That is, the number of subfields of a unit frame may be less than or greater than 8, and allocation of gray-level weights may be changed according to the design specification.

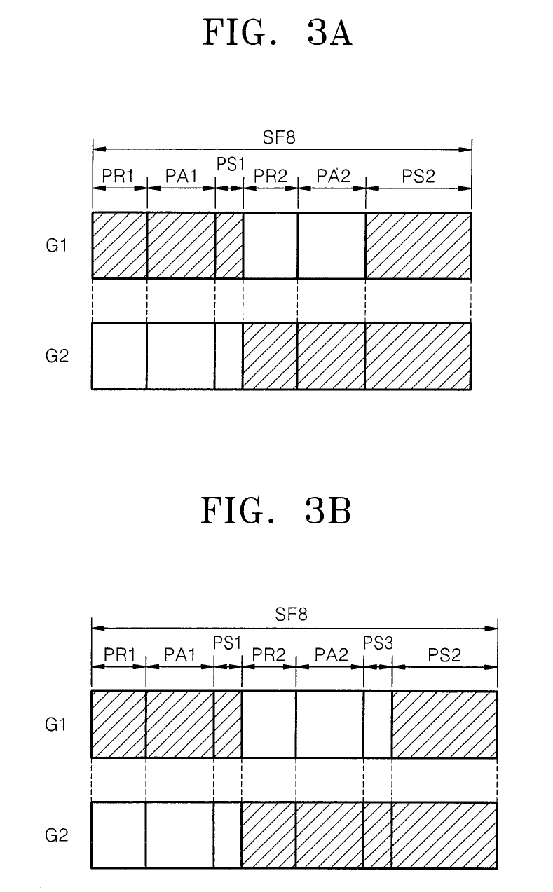

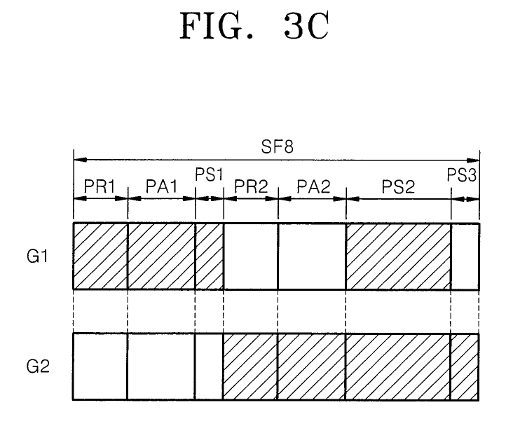

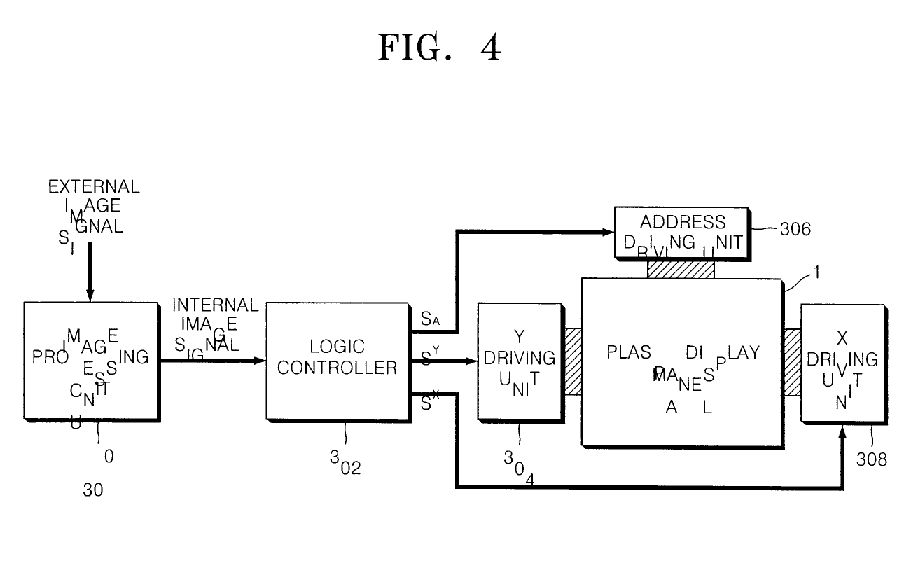

FIGS. 3A through 3C are diagrams illustrating the eighth subfield SF8 illustrated in FIG. 2 in more detail according to embodiments of the present invention.

In FIG. 3A, G1 and G2 denote the first discharge cell group G1 and the second discharge cell group G2, respectively. In one embodiment, in the first reset period PR1, the first address period PA1, and the first sustain period PS1, reset discharge, address discharge, and sustain discharge are respectively performed in the first discharge cell group G1, as indicated by the shading. At these times, reset discharge, address discharge, and sustain discharge are not performed in the second discharge cell group G2. However, if address discharge and sustain discharge were respectively performed in a discharge cell belonging to the second discharge cell group G2 in a preceding subfield (i.e., the seventh subfield SF7) in the second address period PA2 and the second sustain period PS2, sustain discharge may be performed in the first sustain period PS1 of the eighth subfield SF8 a predetermined number of times. In the second reset period PR2 and the second address period PA2, reset discharge and address discharge are respectively performed in the second discharge cell group G2 but are not performed in the first discharge cell group G1. In the second sustain period PS2, sustain discharge is performed in discharge cells addressed in the first address period PA1 and the second address period PA2, regardless of whether the discharge cell belongs to the first discharge cell group G1 or the second discharge cell group G2. If a gray-level weight allocated to the eighth subfield SF8 is 128 and a predetermined number of times that sustain discharge is performed in the first sustain period PS1 is 1, a number of times that sustain discharge is performed in the second sustain period PS2 is 127. That is, the number of times that sustain discharge is performed in the second sustain period PS2, is computed by subtracting a predetermined number of times that sustain discharge is performed in the first sustain period PS1, from a gray-level weight allocated to each subfield.

FIGS. 3B and 3C illustrate that the eighth subfield SF further has a third sustain period PS3 that allows sustain discharge to be further performed in only the second discharge cell group G2 a predetermined number of times, in order to prevent sustain discharge from being performed in the first discharge cell group G1 the predetermined number of times. The third sustain period PS3 may be included in any one of the subfields but in one embodiment, is included in the eighth subfield SF8. In each subfield, sustain discharge is further performed in the first discharge cell group G1 in the first sustain period PS1 the predetermined number of times, which is compensated for since sustain discharge is performed in the second discharge cell group G2 in the first sustain period PS1 of a subsequent field. However, such compensation is not made in the second discharge cell group G2 after the last subfield, i.e., the eighth subfield SF8. For this reason, the third sustain period PS3, in one embodiment, is separately included in the last subfield (i.e., eighth subfield SF8). However, it can be regarded that sustain discharge performed in the second discharge cell group G2 in the eighth subfield SF8 the predetermined number of times, is naturally compensated for in the first sustain period PS1 of a first subfield of a subsequent frame. Thus, the third sustain period PS3 may be selectively included in the eighth subfield SF8 according to a designer's intention.

FIG. 3B illustrates that the third sustain period PS3 is located before the second sustain period PS2. FIG. 3C illustrates that third sustain period PS3 is located after the second sustain period PS2. In the third sustain period PS3, sustain discharge is performed at the same number of times that sustain discharge was performed in the first discharge cell group G1 in the first sustain period PS1. Similarly, FIG. 3A, FIGS. 3B and 3C also illustrate that the eighth subfield SF8 has the first reset period PR1, the first address period PA1, the first sustain period PS1, the second reset period PR2, the second address period PA2, and the second sustain period PS2. Driving waveforms applied in the third sustain period PS3 will later be described with reference to FIGS. 3B and 3C.

FIG. 4 is a schematic block diagram of a plasma display including a plasma display panel to which a method of driving a plasma display panel according to an embodiment of the present invention, is applicable. Referring to FIG. 4, the plasma display panel includes an image processing unit 300, a logic controller 302, a Y driving unit 304, an address driving unit 306, an X driving unit 308, and a plasma display panel 1.

The image processing unit 300 receives an external image signal, such as a PC signal, a DVD signal, a video signal, and/or a TV signal, from the outside, converts the received image signal into a digital signal, processes the digital signal, and outputs an internal image signal. The internal image signal, in one embodiment, includes red (R), green (G), and blue (B) image data, a clock signal, and vertical and horizontal synchronization signals which are 8-bit signals.

The logic controller 302 receives the internal image signal from the image processing unit 300, performs gamma correction, automatic power control (APC), etc. thereon, and outputs a Y driving control signal SY, an A driving control signal SA, and an X driving control signal SX.

The Y driving unit 304 receives the Y driving control signal S_{Y} from the logic controller 304, and applies it to scan electrode lines Y1, . . . , Yn−1. The address driving unit 306 receives the address driving control signal SA from the logic controller 302 and applies it to address electrode lines A1, . . . , Am. The X driving unit 308 receives the X driving control signal S_{X} from the logic controller 302 and applies it to sustain electrode lines X1, . . . , Xn.

The Y driving unit 304 applies a reset pulse to the scan electrode lines Y1, . . . Yn−1 in the first and second reset periods PR1 and PR2. The reset pulse includes a rising pulse and a falling pulse, and the rising pulse and the falling pulse are applied in the form of a ramp pulse in one embodiment. The application of the reset pulse causes wall charges to be accumulated in or canceled from a discharge cell of the first or second discharge cell group G1 or G2, thereby initializing the discharge cell. Also, scan pulses that sequentially transit from logic scan high Vsch to logic scan low Vscl are applied in the first and second address periods PA1 and PA2, and sustain pulses that are respectively at logic high Vs and logic low Vg are applied in the first through third sustain periods PS1 through PS3.

The address driving unit 306 applies a display data signal that is logic data high Va to the address electrode lines A1, . . . , Am in the first and second address periods PA1 and PA2, in synchronization with the scan pulses. Address discharge is performed by the display data signal and the scan pulses.

In the first reset period PR1, the X driving unit 308 applies first voltage Vg to the first discharge cell group G1 of the sustain electrode lines X1, . . . , Xn, and second voltage Vx, which is greater than the first voltage Vg, to the second discharge cell group G2. In the second reset period PR2, the X driving unit 308 applies the first voltage Vg to the second discharge cell group G2 and the second voltage Vx to the first discharge cell group G1. Also, in the first through third sustain periods PS1 through PS3, a sustain pulse that alternately goes to logic low Vg and logic high Vs is applied to the sustain electrode lines X1, . . . , Xn.

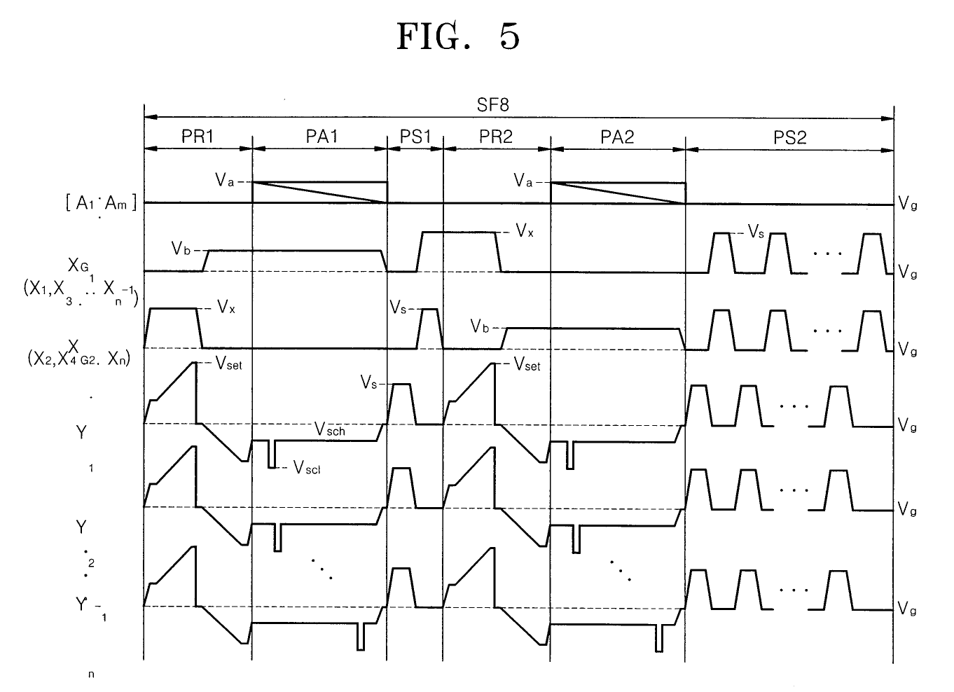

FIG. 5 is a timing diagram of driving signals according to an embodiment of the present invention. In detail, FIG. 5 illustrates driving signals for the eighth subfield SF8. A group of discharge cells formed by the odd-numbered lines X1, X3, . . . , Xn−1 (XG1) of the sustain electrode lines X1, . . . , Xn will be referred to as “first discharge cell group G1”, and a group of discharge cells formed by the even-numbered lines X2, X4, . . . , Xn (XG2) of the sustain electrode lines X1, . . . , Xn will be referred to as “second discharge cell group G2”.

Referring to FIG. 5, the eighth subfield SF8 has a first reset period PR1, a first address period PA1, a first sustain period PS1, a second reset period PR2, a second address period PA2, and a second sustain period PS2.

In the first reset period PR1, reset discharge is performed in only the first discharge cell group G1. To this end, a reset pulse having a rising pulse and a falling pulse is applied to scan electrode lines Y1, . . . , Yn−1. In the embodiment illustrated in FIG. 5, the rising pulse and the falling pulse are applied in the form of a ramp pulse, and the rising pulse reaches logic high Vset. During application of the rising pulse, the first voltage Vg is applied to the sustain electrode lines XG1 of the first discharge cell group G1 so that the potential difference between each scan electrode and each sustain electrode of the first discharge cell group G1 is greater than a discharge firing voltage, and second voltage Vx greater than the first voltage Vg is applied to the sustain electrode lines XG2 of the second discharge cell group G2 so that the potential difference between each scan electrode and each sustain electrode of the second discharge cell group G2 is not greater than the discharge firing voltage. During application of the falling pulse, a third voltage Vb, which is greater than the first voltage Vg, is applied to the sustain electrode lines XG1 of the first discharge cell group G1, and the first voltage Vg is applied to the sustain electrode lines XG2 of the second discharge cell group G2. During application of the reset pulse, the first voltage Vg is continuously applied to address electrode lines A1, . . . , Am. Here, the first voltage Vg may be ground voltage.

The application of the first voltage Vg and the rising pulse causes wall charges having negative polarity to be accumulated around the scan electrodes of the first discharge cell group G1, and wall charge having positive polarity to be accumulated around the sustain electrodes and the address electrodes, thereby causing feeble reset discharge. Although the second voltage Vx and the rising pulse are applied, the potential difference between each scan electrode and each sustain electrode of the second discharge cell group G2 does not reach the discharge firing voltage, and thus, reset discharge does not occur therein.

The application of the third voltage Vb and the falling pulse causes the wall charges having negative polarity to be removed around the scan electrodes of the first discharge cell group G1, and the wall charges having positive polarity to be removed around the sustain electrodes and the address electrodes thereof, causing feeble reset discharge. Although the first voltage Vg and the falling pulse are applied, reset discharge is also not performed in the second discharge cell group G2. Accordingly, after the reset period, the wall charges are initialized in the discharge cells of the first discharge cell group G1 but are not initialized in the discharge cells of the second discharge cell group G2. That is, a small amount of wall charges having negative polarity are accumulated around the scan electrodes of the first discharge cell group G1, wall charges having positive polarity are accumulated around the sustain electrodes, and wall charges having positive polarity are accumulated around the address electrodes.

In the first address period PA1, the discharge cells of only the first discharge cell group G1 are addressed. In the first address period PA1, the third voltage Vb is continuously applied to the sustain electrode lines XG1 of the first discharge cell group G1, the first voltage Vg is continuously applied to the sustain electrode lines XG2 of the second discharge cell group G2, a scan pulse that transitions from logic scan high Vsch to logic scan low Vscl is sequentially applied to all the scan electrode lines Y1, . . . , Yn−1, and a display data signal that is selectively maintained logic data high Va according to the scan pulse is applied to the address electrode lines A1, . . . , Am. In the first discharge cell group G1, address discharge is performed in discharge cells selected to be turned on, in response to the scan pulse and the display data signal (this process is called “addressing”). In the second discharge cell group G2, since initialization is not performed during the first reset period, address discharge is not performed even if the scan pulse and the display data signal are applied. After the first address period PA1, wall charges having positive polarity are accumulated around the scan electrodes of addressed discharge cells of the first discharge cell group G1, and wall charges having negative polarity are accumulated around the sustain electrodes thereof.

In the first sustain period PS1, sustain discharge is performed in the addressed discharge cells a predetermined number of times. Here, the predetermined number of times will be hereinafter described as being 1 for convenience of explanation. but is not limited thereto. That sustain discharge is performed once means that high voltage Vs and low voltage Vg are respectively applied to scan electrodes and sustain electrodes, and then, the low voltage Vg and the high voltage Vs are respectively applied to the scan electrodes and the sustain electrodes.

In the first sustain period PS1, a sustain pulse is alternately applied to all the scan electrode lines Y1, . . . ,Yn−1 and all the sustain electrode lines X1, . . . ,Xn, and the first voltage Vg is applied to the address electrode lines A1, . . . ,Am. That is, the high voltage Vs and the low voltage Vg are sequentially applied to all the scan electrode lines Y1, . . . ,Yn−1, and the low voltage Vg and the high voltage Vs are sequentially applied to all the sustain electrode lines X1, . . . ,Xn.

When the high voltage Vs and the low voltage Vg are respectively applied to scan electrodes and sustain electrodes, sustain discharge is performed in discharge cells addressed by the addressed wall charges, the high voltage Vs and the low voltage Vg. After the sustain discharge, wall charges having negative polarity are accumulated around the scan electrodes of the discharge cells and wall charges having positive polarity are accumulated around the sustain electrodes thereof. When the low voltage Vg is applied to the scan electrodes and the high voltage Vs is applied to the sustain electrodes, sustain discharge is performed in the discharge cells where address discharge (addressing) was performed. After the sustain discharge, wall charges having positive polarity are accumulated around the scan electrodes of the discharge cells and wall charges having negative polarity are accumulated around the sustain electrodes. As described above, sustain discharge is performed once in the addressed discharge cells in the first sustain period PS1. Here, the addressed discharge cells are discharge cells belonging to the first discharge cell group G1, which are addressed in the first address period PA1, but are not limited thereto. For example, the addressed discharge cells may be discharge cells belonging to the second discharge cell group G2, which were addressed in the second address period PA2 of the preceding subfield (i.e., the seventh subfield) and in which sustain discharge was performed in the second sustain period PS2 of the preceding subfield.

In the second reset period PR2, reset discharge is performed in only the second discharge cell group G2. To this end, in one embodiment, a reset pulse including a rising pulse and a falling pulse is applied to the scan electrode lines Y1, . . . ,Yn−1. The rising pulse reaches logic high Vset. The rising pulse and the falling pulse may be applied in the form of a ramp pulse. During application of the rising pulse, the first voltage Vg is applied to the sustain electrode lines XG2 of the second discharge cell group G2 so that the potential difference between each scan electrode and each sustain electrode of the second discharge cell group G2 exceeds the discharge firing voltage, and the second voltage Vx, which is greater than the first voltage Vg, is applied to the sustain electrode lines XG1 of the first discharge cell group G1 so that the potential difference between each scan electrode and each sustain electrode of the first discharge cell group G1 does not exceed the discharge firing voltage. During application of the falling pulse, the third voltage Vb, which is greater than the first voltage Vg, is applied to the sustain electrode lines XG2 of the second discharge cell group G2, and the first voltage Vg is applied to the sustain electrode lines XG1 of the first discharge cell group G1. During application of the reset pulse, the first voltage Vg is continuously applied to the address electrode lines A1, . . . , Am. Here, the first voltage Vg may be a ground voltage.

The application of the first voltage Vg and the rising pulse causes wall charges having negative polarity to be accumulated around the scan electrodes of the second discharge cell group G2 and wall charges having positive polarity to be accumulated around the sustain electrodes and the address electrodes of the second discharge cell group G2, thereby performing weak reset discharge. Although the second voltage Vx and the rising pulse are applied, the potential difference between each scan electrode and each sustain electrode of the first discharge cell group G1 does not reach the discharge firing voltage, thereby preventing reset discharge from occurring.

The application of the third voltage Vb and the falling pulse causes the accumulated wall charge having negative polarity to be cancelled from around the scan electrodes of the second discharge group G2, and the accumulated wall charges having positive polarity to be cancelled from around the sustain electrodes and the address electrodes thereof, thereby performing weak reset discharge. Although the first voltage Vg and the falling pulse are applied, reset discharge is not also performed in the first discharge cell group G1. Thus, when the reset period ends, the state of wall charges is initialized in the discharge cells of the second discharge cell group G2 but the state of wall charges is not initialized in the discharge cells of the first discharge cell group G1. That is, a small amount of wall charges having negative polarity are accumulated only around the scan electrodes of the second discharge cell group G2, wall charges having positive polarity are accumulated around the sustain electrodes, and wall charges having positive polarity are accumulated around the address electrodes. The state of wall charges formed in the discharge cells of the first discharge cell group G1 when the first sustain period PS1 ends, is maintained.

In the second address period PA2, the discharge cells of only the second discharge cell group G2 are addressed. In the second address period PA2, the third voltage Vb is continuously applied to the sustain electrode lines XG2 of the second discharge cell group G2, the first voltage Vg is continuously applied to the sustain electrode lines XG1 of the first discharge cell group G1, a scan pulse that transitions from logic scan high Vsch to logic scan low Vscl is sequentially applied to all the scan electrode lines Y1, . . . ,Yn−1, and a display data signal that selectively transitions to logic data high Va in synchronization with the scan pulse is applied to the address electrode lines A1, . . . , Am. In the second discharge cell group G2, address discharge is performed in discharge cells, which are selected to be turned on, in response to the scan pulse and the display data signal. Such a process is called addressing. The first discharge cell group G1 was not initialized in the second reset period PR2, and therefore, address discharge is not performed in the first discharge cell group G1 even if the scan pulse and the display data signal are applied thereto. When the second address period PA2 ends, wall charges having positive polarity and wall charges having negative polarity are respectively accumulated around the scan electrodes and the sustain electrodes of the addressed discharge cells of the second discharge cell group G2.

In the second sustain period PS2, sustain discharge is performed in the addressed discharge cells. An addressed discharge cell refers to discharge cell addressed in the first address period PA1 or the second address period PA2. Here, a number of times that sustain discharge is performed, is computed by subtracting a predetermined number of times that sustain discharge is performed in the first sustain period PS1 from a gray-level weight allocated to a corresponding subfield. If a gray-level weight allocated to the eighth subfield SF8 is 128, a number of times that sustain discharge is performed in the second sustain period PS2 of the eighth subfield SF8, is 127.

In the second sustain period PS2, a sustain pulse is alternately applied to all the scan electrodes lines Y1, . . . ,Yn−1 and the sustain electrode lines X1, . . . ,Xn, and the first voltage Vg is applied to the address electrode lines A1, . . . ,Am. That is, the high voltage Vs and the low voltage Vg are sequentially applied to all the scan electrodes lines Y1, . . . ,Yn−1, and the low voltage Vg and the high voltage Vs are sequentially applied to all the sustain electrode lines X1, . . . ,Xn.

When the high voltage Vs and the low voltage Vg are applied to a scan electrode and a sustain electrode, sustain discharge is performed in a discharge cell addressed by the addressed wall charges, the high voltage Vs and the low voltage Vg. After the sustain discharge, wall charges having negative polarity are accumulated around the scan electrode of the discharge cell, and wall charges having positive polarity are accumulated around the sustain electrode of the discharge cell. When the low voltage Vg and the high voltage Vs are respectively applied to the scan electrode and the sustain electrode, sustain discharge is performed in the discharge cell in which address discharge (addressing) has been performed. After the sustain discharge, wall charges having positive polarity are accumulated around the scan electrode of the discharge cell and wall charges having negative polarity are accumulated around the sustain electrode. In the second sustain period PS2, sustain discharge is performed a number of times, which is computed by subtracting a predetermined number of times that sustain discharge is performed in the first sustain period PS1, from a gray-level weight allocated to a subfield. In the eighth subfield SF8, sustain discharge is performed 127 times.

Although not shown in the drawings, in the first and second reset periods PR1 and PR2, it is possible to apply an erasure pulse to the scan electrode lines Y1, . . . ,Yn−1 or the sustain electrode lines X1, . . . ,Xn, prior to the application of the rising pulse. Here, the erasure pulse is applied to erase sustain discharge performed in the second sustain period PS2 of a previous subfield (the seventh subfield). When the erasure pulse is applied to the scan electrode lines Y1, . . . ,Yn−1, it may be applied in the form of a falling pulse whose voltage is sequentially falling. When the erasure pulse is applied to the sustain electrode lines X1, . . . ,Xn, it may be applied in the form of a rising pulse whose voltage is sequentially rising.

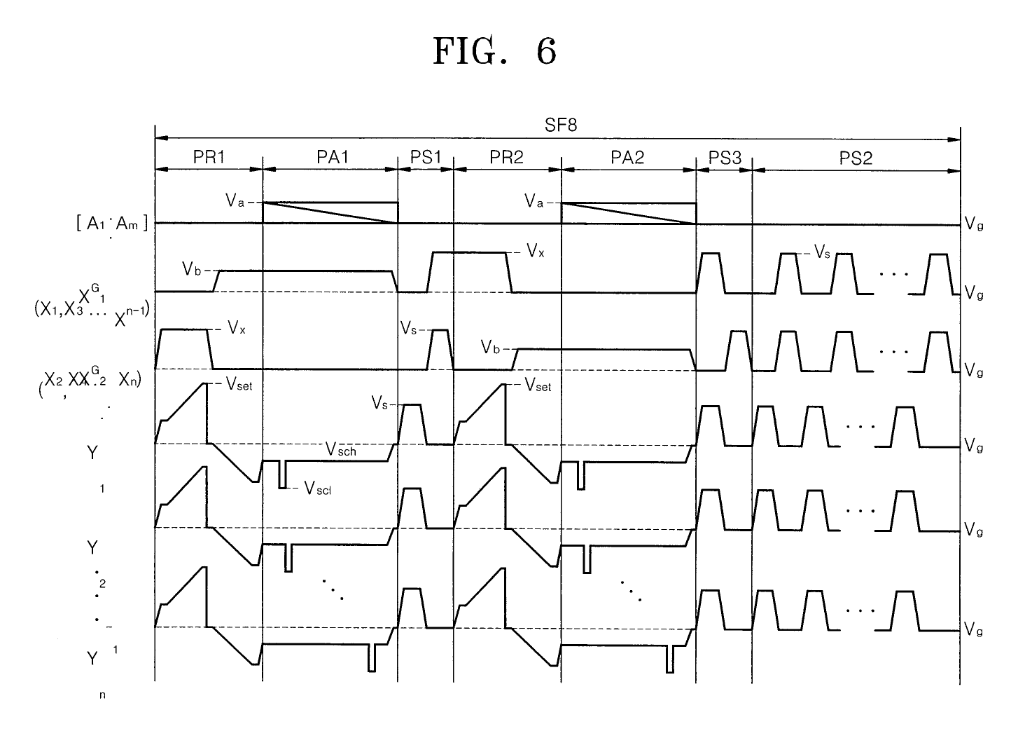

FIG. 6 is a timing diagram of driving signals according to another embodiment of the present invention. The driving signals illustrated in FIG. 6 are similar to those illustrated in FIG. 5, and thus will be described primarily in reference to the difference between the driving signals illustrated in FIGS. 5 and 6. Referring to FIG. 6, driving signals applied to a first reset period PR1, a first address period PA1, a first sustain period PS1, a second reset period PR2, a second address period PA2, and a second sustain period PS2 are substantially the same as illustrated in FIG. 6. However, referring to FIG. 6, a third sustain period PS3 is further included between the second address period PA2 and the second sustain period PS2 so as to compensate for sustain discharge being further performed a predetermined number of times (e.g., once) in the first discharge cell group G1 in the first sustain period PS1.

In the third sustain period PS3, in one embodiment, sustain discharge is controlled not to be performed in the first discharge cell group G1 and to be performed in the second discharge cell group G2. To this end, high voltage Vs and low voltage Vg may be sequentially applied to the scan electrode lines Y1, . . . ,Yn−1, the high voltage Vs and the low voltage Vg may be sequentially applied to the sustain electrode lines XG1 of the first discharge cell group G1, and the low voltage Vg and the high voltage Vs may be sequentially applied to the sustain electrode lines XG2 of the second discharge cell group G2. When the high voltage Vs is applied to a scan electrode, and a sustain electrode of the first discharge cell group G1, and the high voltage Vs is applied to a sustain electrode of the first discharge cell group G1, the potential difference between the sustain electrode and the scan electrode of the first discharge cell group G1 does not reach a discharge firing voltage, thereby preventing sustain discharge, but the potential difference between the sustain electrode and the scan electrode of the second discharge cell group G2 reaches the discharge firing voltage, thereby performing sustain discharge. When the low voltage Vg is applied to the scan electrode, and the sustain electrode of the first discharge cell group G1, and the high voltage Vs is applied to the sustain electrode of the second discharge cell group G2, the potential difference between the sustain electrode and the scan electrode of the first discharge cell group G1 does not reach a discharge firing voltage, thereby preventing sustain discharge, but the potential difference between the sustain electrode and the scan electrode of the second discharge cell group G2 reaches the discharge firing voltage, thereby performing sustain discharge. A number of times that sustain discharge is performed in the third sustain period PS3 is preferably equal to a number of times that sustain discharge is performed in the first sustain period PS1. An electric potential of the high voltage Vs applied to the sustain electrode of the first discharge cell group G1 may be equal to the potential difference between the low voltage Vs and the high voltage Vs applied to the scan electrode. The range of the electric potential of the high voltage Vs is not limited if it does not allow discharge to be performed. The third sustain period PS3 may be located in at least one subfield of a plurality of subfields of a unit frame, but is preferably located in the last subfield of the subfields. FIG. 6 illustrates that the third sustain period PS3 is located in the eighth subfield SF8

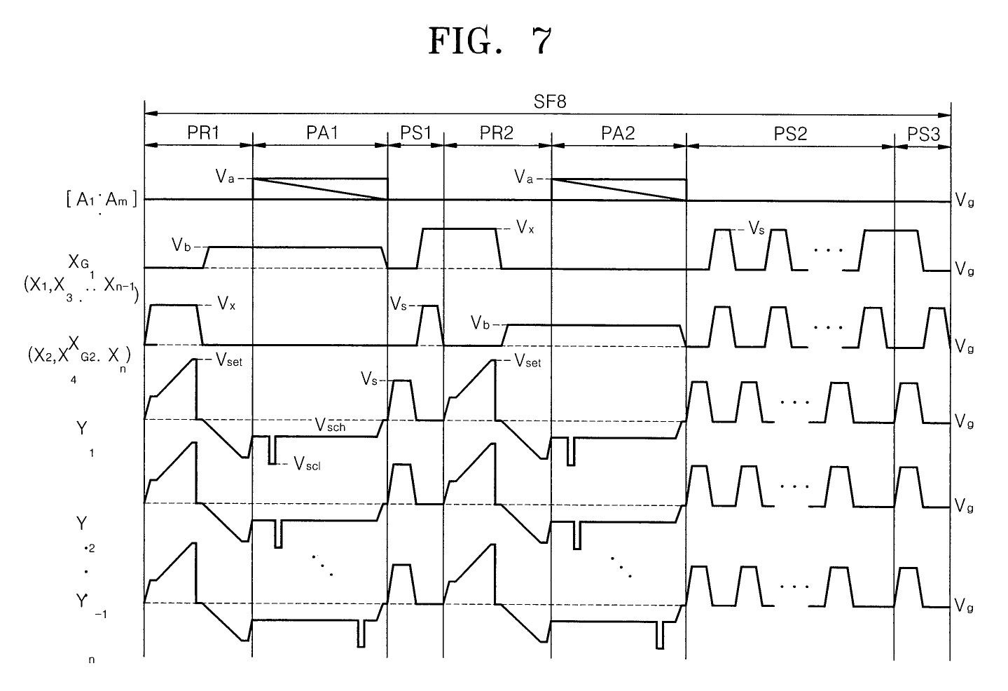

FIG. 7 is a timing diagram of driving signals according to another embodiment of the present invention. The driving signals illustrated in FIG. 7 are similar to those illustrated in FIG. 5, and thus will be described primarily in reference to the difference between the driving signals illustrated in FIGS. 5 and 7. Referring to FIG. 7, driving signals applied to a first reset period PR1, a first address period PA1, a first sustain period PS1, a second reset period PR2, a second address period PA2, and a second sustain period PS2 are substantially the same as illustrated in FIG. 6. However, referring to FIG. 7, a third sustain period PS3 is further located after the second sustain period PS2 so as to compensate for sustain discharge being further performed a predetermined number of times (once) in the first discharge cell group G1 in the first sustain period PS1.

In the third sustain period PS3, in one embodiment, sustain discharge is controlled not to be performed in the first discharge cell group G1 but be performed in the second discharge cell group G2. To this end, high voltage Vs and low voltage Vg may be sequentially applied to the scan electrode lines Y1, . . . ,Yn−1, the high voltage Vs and the low voltage Vg may be sequentially applied to the sustain electrode lines XG1 of the first discharge cell group G1, and the low voltage Vg and the high voltage Vs are sequentially applied to the sustain electrode lines XG2 of the second discharge cell group G2. When the high voltage Vs is applied to a scan electrode, and a sustain electrode of the first discharge cell group G1, and the low voltage Vg is applied to a sustain electrode of the second discharge cell group G2, the potential difference between the sustain electrode and the scan electrode of the first discharge cell group G1 does not reach a discharge firing voltage, thereby preventing sustain discharge, but the potential difference between the sustain electrode and the scan electrode of the second discharge cell group G2 reaches the discharge firing voltage, thereby performing sustain discharge. When the low voltage Vg is applied to the scan electrode, and the sustain electrode of the first discharge cell group G1, and the high voltage Vs is applied to the sustain electrode of the second discharge cell group G2, the potential difference between the sustain electrode and the scan electrode of the first discharge cell group G1 does not reach the discharge firing voltage, thereby preventing sustain discharge, but the potential difference between the sustain electrode and the scan electrode of the second discharge cell group G2 reaches the discharge firing voltage, thereby performing sustain discharge. A number of times that sustain discharge is performed in the third sustain period PS3, in one embodiment, is equal to a number of times that sustain discharge is performed in the first sustain period PS1. The electric potential of the high voltage Vs applied to the sustain electrode of the first discharge cell group G1 may be the potential difference between the low voltage Vg and the high voltage Vs applied to the scan electrode. Here, the range of the electric potential of the high voltage Vs is not limited if it does not allow discharge to be started. The third sustain period PS3 may be located in at least one subfield of a plurality of subfields of a unit frame, but is located in the last subfield of the subfields in one embodiment. FIG. 7 illustrates that the third sustain period PS3 is located in the eighth subfield SF8.

As described above, the inclusion of the first sustain period PS1 reduces a waiting time incurred between addressing and sustain discharge which are performed in the first discharge cell group G1, when performing the ALIS method that performs addressing for each group, thereby stably performing sustain discharge in the first discharge cell group G1. Also, sustain discharge is further performed a predetermined number of times in the first sustain period PS1 of a subsequent subfield in a discharge cell belonging to the second discharge cell group G2 in which sustain discharge has been performed in the second sustain period PS2. Thus, a waiting time between previous sustain discharge and reset discharge is reduced, thus stably performing reset discharge in the second discharge cell group G2.

As described above, the embodiments of the present invention have one or more of the following features. First, since the first sustain period is included in each subfield, it is possible to reduce a waiting time between addressing and sustain discharge in the first discharge cell group, thereby stably performing sustain discharge in the first discharge cell group.

Second, since the first sustain period is included in each subfield, sustain discharge is further performed a predetermined number of times in a discharge cell, which belongs to the second discharge cell group in which sustain discharge has been performed, in the first sustain period of a subsequent subfield. Accordingly, a waiting time between previous sustain discharge and reset discharge is reduced, thereby stably performing reset discharge in the second discharge cell group.

Third, the arrangement of electrodes to which a method of driving a plasma display panel according to the present invention is applied, allows the number of electrode lines to be reduced and a plasma display panel to be driven at a high-definition rate.

While this invention has been particularly shown and described with reference to exemplary embodiments thereof, it will be understood by those skilled in the art that various changes in form and details may be made therein without departing from the spirit and scope of the invention as defined by the appended claims and their equivalents.

What is claimed is:

1. A method of driving a plasma display panel comprising first electrode lines extending in a first direction, second electrode lines each being located between adjacent ones of the first electrode lines and extending in parallel with the first electrode lines, and third electrode lines extending to cross the first and second electrode lines, wherein discharge cells are defined where the first, second and third electrode lines cross, the first electrode lines comprise first type electrode lines and second type electrode lines that are alternately arranged, and the discharge cells comprise a first discharge cell group defined by the first type electrode lines and a second discharge cell group defined by the second type electrode lines, the method comprising:
performing a first address operation for selecting one or more of the discharge cells in the first discharge cell group;
performing a first sustain operation in said one or more of the discharge cells selected in the first address operation;
performing a second address operation for selecting one or more of the discharge cells in the second discharge cell group; and
performing a second sustain operation in said one or more of the discharge cells selected in the first address operation and said one or more of the discharge cells selected in the second address operation.

2. The method of claim 1, further comprising:
performing a first reset operation for initializing the first discharge cell group before the first address operation; and
performing a second reset operation for initializing the second discharge cell group before the second address operation.

3. The method of claim 2, wherein a unit frame for displaying an image on the plasma display panel comprises a plurality of subfields, each subfield comprising the first reset operation, the first address operation, the first sustain operation, the second reset operation, the second address operation, and the second sustain operation.

4. The method of claim 3, wherein sustain discharge is performed in a discharge cell among the discharge cells in the second discharge cell group, which is addressed in the second address operation of a subfield right before a current subfield among the subfields, in the first sustain operation of the current subfield.

5. The method of claim 3, wherein, in the first sustain operation, sustain discharge is performed a predetermined number of times, and
a sum of numbers of times that sustain discharge is respectively performed in the first and second sustain operations, corresponds to a gray-level weight allocated to each of the subfields.

6. The method of claim 5, wherein at least one subfield among the subfields further comprises a third sustain operation in which sustain discharge is performed in only the second discharge cell group so as to compensate for sustain discharge being performed in the second discharge cell group less frequently than in the first discharge cell group.

7. The method of claim 6, wherein a last subfield among the subfields comprises the third sustain operation.

8. The method of claim 7, wherein the third sustain operation is performed before performing the second sustain operation.

9. The method of claim 7, wherein the third sustain operation is performed after performing the second sustain operation.

10. The method of claim 7, wherein, in the third sustain operation, a sustain pulse which transitions from logic high to logic low is applied to the second electrode lines of the first discharge cell group, and
a sustain pulse which transitions from logic low to logic high is applied to the second electrode lines of the second discharge cell group.

11. The method of claim 5, wherein the predetermined number of times is 1.

12. The method of claim 2, wherein, in the first reset operation, a reset pulse comprising a rising pulse and a falling pulse is applied to the second electrode lines,
wherein, during application of the rising pulse, a first voltage is applied to the first electrode lines of the first discharge cell group in order to perform reset discharge, and a second voltage is applied to the first electrode lines of the second discharge cell group in order not to perform reset discharge, wherein the second voltage is greater than the first voltage.

13. The method of claim 12, wherein, during application of the falling pulse, a third voltage is applied to the first electrode lines of the first discharge cell group and the first voltage is applied to the first electrode lines of the second discharge cell group, wherein the third voltage has positive polarity and is greater than the first voltage.

14. The method of claim 12, wherein, before application of the rising pulse and the falling pulse, an erasure pulse is applied to the first electrode lines or the second electrode lines, wherein the erasure pulse is performed for erasing sustain discharge in one or more of the discharge cells.

15. The method of claim 2, wherein, in the second reset operation, a reset pulse comprising a rising pulse and a falling pulse is applied to the second electrode lines,
wherein, during application of the rising pulse, a first voltage is applied to the first electrode lines of the second discharge cell group so as to perform reset discharge and a second voltage is applied to the first electrode lines of the first discharge cell group so as not to perform reset discharge, wherein the second voltage is greater than the first voltage.

16. The method of claim 15, wherein, during application of the falling pulse, a third voltage is applied to the first electrode lines of the second discharge cell group and the first voltage is applied to the first electrode lines of the first discharge cell group, wherein the third voltage has positive polarity and is greater than the first voltage.

17. The method of claim 1, wherein, in the first address operation, a scan pulse is sequentially applied to the second electrode lines and a display data signal is applied to the third electrode lines so as to perform address discharge in the first discharge cell group.

18. The method of claim 1, wherein, in the first address operation, a sustain pulse is alternately applied to the first electrode lines and the second electrode lines so as to perform sustain discharge in the selected one or more of the discharge cells a predetermined number of times.

19. The method of claim 1, wherein, in the second address operation, a scan pulse is sequentially applied to the second electrode lines and a display data signal is applied to the third electrode lines so as to perform address discharge in the second discharge cell group.

20. The method of claim 1, wherein, in the second sustain operation, a sustain pulse is alternately applied to the first electrode lines and the second electrode lines so as to perform sustain discharge in the addressed discharge cell.
